(19) United States
(12) Patent Application Publication
(10) Pub. No.: US 2016/0103082 A1
(43) Pub. Date: Apr. 14, 2016

(54) HYDROGEN GAS SENSOR WITH CONCENTRATION FUNCTION AND HYDROGEN GAS SENSOR PROBE USED IN SAME

(71) Applicant: Mitsuteru KIMURA, Miyagi (JP)

(72) Inventor: Mitsuteru KIMURA, Miyagi (JP)

(21) Appl. No.: 14/892,737

(22) PCT Filed: May 22, 2014
(86) PCT No.: PCT/JP2014/063617

§ 371 Date: Nov. 20, 2015

(30) Foreign Application Priority Data
May 23, 2013 (JP) 2013-109375

(51) Int. Cl. G01N 25/20

(52) U.S. Cl. CPC G01N 25/20

(57) ABSTRACT

A hydrogen gas sensor element and a hydrogen gas concentration part which has, on a membrane thermally isolated from a substrate, a heater, a temperature sensor and a hydrogen gas absorbing substance are provided in the same microchamber. Hydrogen gas is released from the concentration part and highly concentrated due to heat applied by the heater, and the highly concentrated hydrogen gas is measured by the hydrogen gas sensor element. Because the hydrogen gas absorbing substance exhibits selectivity for hydrogen gas, there is no need for the hydrogen gas sensor element to exhibit selectivity for hydrogen gas. An airflow limiting part is provided in the exit/entrance opening of the microchamber, whereby dilution of hydrogen gas by the entrance of external airflow is prevented. Introduction of the gas to be investigated into the microchamber is performed at predetermined intervals using an introduction means such as a pump.

### CROSS-REFERENCE TO RELATED APPLICATIONS

This application is a U.S. National Stage Application of International Application No. PCT/JP2014/063617, filed on May 22, 2014, which claims priority to Japanese Patent Application No. 2013-109375, filed on May 23, 2013. The entire disclosures of the above applications are incorporated herein by reference.

### BACKGROUND

1. Technical Field

The present invention relates to a hydrogen gas sensor and a hydrogen gas sensor probe used in the same. More specifically, the present invention relates to a hydrogen gas sensor and its sensor probe used for a hydrogen gas leak detector and the like which has high selectivity to hydrogen gas and which also has high sensitivity obtained by concentrating hydrogen gas in external gas.

2. Background Art

The concentration of hydrogen gas, also called H2, is about 0.5 ppm in natural air. This value is smaller than that of helium, which is about 5 ppm. Therefore, hydrogen gas is suitable for a leak detector, achieving high resolution. However, it has been known that there is a risk of explosion in an extremely broad range when a hydrogen gas exists in the air in an amount of 4.0 to 75.0% (% by volume). Accordingly, it is important to measure the hydrogen gas concentration in a low concentration at the lower explosion limit of 4.0% or less. Heretofore, as a highly sensitive hydrogen gas sensor, there has been known a catalytic combustion type hydrogen gas detection sensor (see Japanese Patent Publication No. 2006-201100) for measuring hydrogen gas in which the temperature of a catalyst such as Pt is raised by a heater and the catalytic action in a high temperature region is utilized.

Also, as a semiconductor gas sensor, there has been known a sensor in which change in electric resistance is measured during heating by utilizing change in carrier density at the surface of the semiconductor due to adsorption or a reduction reaction of reducing gas. However, since such a sensor reacts to all kinds of reducing gas, it does not have selectivity to hydrogen.

In addition, there was a sensor which has been heightened gas selectivity by utilizing absorption or permeation of a specified gas such as hydrogen. For example, as a device to detecting hydrogen by utilizing a hydrogen storage alloy, there has been known a hydrogen-detecting device (see Japanese Patent Publication No. H10-73530) which detects a hydrogen-absorption amount based on the size of the detected strain in which the hydrogen storage alloy is adhered to one surface of a substrate, and a strain gage is attached to the other surface, and the strain of the substrate caused by volume expansion of the hydrogen storage alloy when it absorbs the hydrogen is detected by the strain gage.

It has also been proposed a hydrogen detecting device (see Japanese Patent Publication No. 2005-249405) for detecting a concentration of a hydrogen gas contained in a gas by utilizing a hydrogen storage alloy having high selectivity of hydrogen and detecting change in the state (weight change) when the hydrogen is absorbed while maintaining the hydrogen storage alloy to a constant temperature.

Heretofore, as a temperature sensor, there are an absolute temperature sensor which can measure the absolute temperature and a temperature difference sensor which can measure the temperature difference alone. As the absolute temperature sensor which can measure the absolute temperature, there are a thermistor, a transistor thermistor (See Japanese Patent No. 3366590) which uses a transistor as a thermistor and a diode thermistor (See Japanese Patent No. 3583704) which uses a diode as a thermistor, which are invented by the present applicant, and further an IC temperature sensor in which the temperature is in a linear relationship with a forward voltage of a diode or a voltage between emitter bases of a transistor. Moreover, as the temperature difference sensor which can measure the temperature difference alone, there have been a thermocouple and a thermopile in which the thermocouples are connected in series to increase output voltage.

It has heretofore been proposed a hydrogen sensor mainly characterized by being constituted by a microcapsule means for encapsulating powder particles of a hydrogen storage alloy with a metal film, a temperature detecting end means by a thermocouple, an integrating means in which the powder of the hydrogen storage alloy encapsulated by the microcapsule means and the thermocouple as the temperature detecting end means are contained in a cap, and an electronic controlling means by an electronic controlling portion including a power source (See Japanese Patent Publication No. 2004-233097).

The present inventor has also invented previously “a gas sensor element and a gas concentration measurement device using the same” (see Japanese Patent Publication No. 2008-111822) and proposed a gas sensor element and a gas concentration measurement device which are intended to measure the concentration of a hydrogen gas in which one or a plural number of temperature sensors and a gas-absorbing substance which absorbs a gas to be detected are provided to a thin film thermally separated from a substrate, and the temperature sensors are so provided that temperature change accompanied by heat absorption or heat generation at the time of absorption or release of the gas to be detected can be measured. Subsequently, the present inventor has invented “a specified gas concentration sensor” (PCT/JP2011/070427), proposed a hydrogen gas sensor of high-speed response within 1 second in which the temperature is measured after the time several times as great as a thermal time constant after stopping heating passes to measure the hydrogen gas concentration by utilizing a microminiature cantilever shape thin film provided with a hydrogen absorbing film, and further proposed a hydrogen gas sensor in which a heat conduction type can be also used in measuring the hydrogen gas concentration in a high concentration at 3% or more. After that, he has conducted experiments and improvement thereof, and as a result, the best embodiments for making hydrogen (H2) gas highly sensitive in an extremely low concentration at about 1 ppm or less can be obtained in the present invention.

In a hydrogen gas-detection sensor in a catalytic combustion type as shown in Japanese Patent Publication No. 2006-201100, it is so constituted that burning is done at a relatively low temperature using a catalyst in which fine particles such as Pt are carried on an oxide under heating with a heater, and heat of reaction is utilized for detection, but selectivity of the gas is poor since it is reacted with a gas so long as it is a combustible gas. Moreover, it requires a temperature of 100° C. or higher even when it is said to be a low temperature using a catalyst, and the presence of oxygen in the air is indispensable since an action of combustion is utilized. In particular, a minute amount of a hydrogen gas concentration is to be measured during heating with the heater, it is necessary to control the heating temperature of the heater to be stable, and further a minute temperature rise is to be measured at high temperatures so that problems in the point of precision in the control circuit or the detection circuit are exposed. Also, it utilizes a catalytic reaction in order to deflagrate at a temperature as low as possible, and the surface state of the catalyst is important in the catalytic reaction but there are problems that the surface state of the catalyst has changed with a lapse of time by repeating heating and cooling for the purpose of making the surface porous or forming the catalyst by dispersing fine particles of platinum (Pt) in the oxide or catalytic properties has been changed due to change in the size of fine particles of platinum (Pt). Accordingly, it has been desired to provide a stable specified gas concentration sensor which can ignore the change with a lapse of time and which can operates at a low temperature without using a catalyst.

There has been also known a semiconductor gas sensor which utilizes gas adsorption at the surface of the semiconductor, but there is a problem that it reacts to any kind of reducing gas. In a sensor which uses a hydrogen storage alloy and a hydrogen gas concentration is detected from the extent of strain at the time of absorbing hydrogen as shown in Japanese Patent Publication No. H10-73530, it is suitable for detecting a high concentration of hydrogen, but it is not suitable for detecting a wide range of gas concentrations from a low concentration to a high concentration, and further there is a problem of fatigue since it utilizes physical deformation. In a sensor shown in Japanese Patent Publication No. 2005-249405, there are problems that the Peltier element consumes a large electric power and the sensor itself inevitably becomes a large size. In a sensor shown in Japanese Patent Publication No. 2004-233097, there are problems that it is necessary to have a microencapsulating means for encapsulating powder particles of the hydrogen storage alloy with a metal film, it is not suitable for mass production, its heat capacity is large, being a sensor which takes a time of several minutes or longer for detecting the hydrogen gas concentration. Accordingly, a high-speed response has been required.

In a hydrogen gas sensor proposed by the present inventor shown in Japanese Patent Publication No. 2008-111822, the hydrogen gas concentration cannot be determined only by the temperature rise due to heat generation and it is required to measure the temperature rise and the like utilizing a different mechanism. To solve this problem, the present inventor has invented “a specified gas concentration sensor” (PCT/JP2011/070427), proposed a hydrogen gas sensor of high-speed response within 1 second in which the temperature is measured after the time several times as great as a thermal time constant after stopping heating passes to measure the concentration of a hydrogen gas by utilizing a microminiature cantilever shape thin film provided with a hydrogen absorbing film for measuring the hydrogen gas concentration in a low concentration at 3% or less, and further proposed a hydrogen gas sensor in which a heat conduction type can be also used in measuring the hydrogen gas concentration in a high concentration at 3% or more. However, since the hydrogen (H2) gas sensitivity in a low concentration at about 1 ppm or less is low, a hydrogen gas sensor which is made highly sensitive for detecting and measuring hydrogen gas in a low concentration has been required.

In the present invention, which has been invented considering the above problems, a hydrogen gas sensor in “a specified gas concentration sensor” (PCT/JP2011/070427) previously invented by the present inventor is improved to have high sensitivity so that it can detect hydrogen gas in a low concentration at about 1 ppm or less and can adopt other types of microminiature hydrogen gas sensor elements. The present invention is intended to provide a small and inexpensive hydrogen gas sensor and its probe with mass productivity, high selectivity to gas, high sensitivity, and high accuracy.

### SUMMARY OF THE INVENTION

To achieve the above purpose, one aspect of the present invention provides a hydrogen gas sensor including an airflow restriction part in a communicating hole connecting external gas which includes hydrogen gas to be detected and a chamber, a concentration part for the hydrogen gas and a hydrogen gas sensor element in the chamber, a hydrogen absorber, a heater, and a temperature sensor in the concentration part, an introduction means for introducing the external gas into the chamber, wherein the introduction means introduces the external gas into the chamber, wherein the hydrogen gas is heated by the heater and discharged into the chamber to concentrate the hydrogen gas in the chamber with the airflow restriction part after the hydrogen gas is absorbed by the concentration part, and wherein the hydrogen gas sensor element outputs information on the concentrated hydrogen gas in the chamber to calculate a hydrogen gas concentration in the external gas on the basis of calibration data previously prepared.

### BRIEF DESCRIPTION OF THE DRAWINGS

FIG. 1 is a cross-sectional schematic view illustrating an embodiment 1 of the hydrogen gas sensor probe 600 equipped with the tube 160 characterizing the hydrogen gas sensor in the present invention.

FIG. 2 is a cross-sectional schematic view along Y-Y line in FIG. 1.

FIG. 3 is a plane schematic view illustrating the embodiment 1 of the substrate 1 in the hydrogen gas sensor probe 600 characterizing the hydrogen gas sensor in the present invention.

FIG. 4 is a cross-sectional schematic view illustrating an embodiment 2 of the hydrogen gas sensor probe 600 equipped with the tube 160 characterizing the hydrogen gas sensor in the present invention.

FIG. 5 is a plane schematic view illustrating the embodiment 2 of the cover 2 equipped with the hydrogen gas sensor element 500 in the hydrogen gas sensor probe 600 illustrated in FIG. 4.

FIG. 6 is a cross-sectional schematic view illustrating an embodiment 3 of the hydrogen gas sensor probe 600 equipped with the tube 160 characterizing the hydrogen gas sensor in the present invention.

FIG. 7 is a cross-sectional schematic view illustrating an embodiment 4 of the hydrogen gas sensor probe 600 equipped with the tube 160 characterizing the hydrogen gas sensor in the present invention.

FIG. 8 is a diagram illustrating the embodiments 1 through 4 of the configuration in the hydrogen gas sensor in the present invention.

### DETAILED DESCRIPTION

As described above, one aspect of the present invention provides a hydrogen gas sensor including an airflow restriction part 250 in a communicating hole 200 connecting external gas which includes hydrogen gas to be detected and a chamber 100, a concentration part 300 for the hydrogen gas and a hydrogen gas sensor element 500 in the chamber, a hydrogen absorber 5, a heater 25, and a temperature sensor 20 in the concentration part 300, an introduction means 150 for introducing the external gas into the chamber 100, wherein the introduction means 150 introduces the external gas into the chamber 100, wherein the hydrogen gas is heated by the heater 25 and discharged into the chamber 100 to concentrate the hydrogen gas in the chamber 100 with the airflow restriction part 250 after the hydrogen gas is absorbed by the concentration part 300, and wherein the hydrogen gas sensor element 500 outputs information on the concentrated hydrogen gas in the chamber 100 to calculate a hydrogen gas concentration in the external gas on the basis of calibration data previously prepared.

It is generally known that the hydrogen storage alloy as the hydrogen absorber 5 generates an exothermic reaction when it absorbs hydrogen and it can absorb hydrogen more than a thousand times larger than its volume under one atmosphere pressure at room temperature. Generally, the lower the temperature is, the larger volume of hydrogen is absorbed with an exothermic reaction. For example, it absorbs hydrogen in the air under one atmosphere pressure while generating heat. It is also known that it discharges the absorbed hydrogen as hydrogen gas when the temperature is raised. Therefore, when hydrogen in the external gas absorbed in the hydrogen absorber 5 in the concentration part 300 inserted in the small chamber 100 is discharged by raising the temperature with the heater 25, the hydrogen concentration in the small chamber 100 is increased, namely, hydrogen can be concentrated. According to references, at room temperature 20° C., hydrogen partial pressure is extremely small when absorbed in palladium, which rapidly absorbs hydrogen to reach equilibrium. Palladium generates an exothermic reaction while absorbing hydrogen. The exothermic reaction stops when palladium reaches equilibrium. Inside partial pressure of hydrogen in palladium tends to increase exponentially with temperature T. It is also known that the inside partial pressure reaches one atmosphere pressure when the temperature of palladium reaches about 160° C. Therefore, hydrogen absorbed in palladium can be ejected in the course of raising the temperature to about 200° C., and the temperature can be raised by making hydrogen absorbed in the course of cooling palladium to room temperature. The present invention provides a hydrogen gas sensor which can measure hydrogen gas of extremely low concentration, utilizing concentrating action for hydrogen gas of the hydrogen absorber 5 such as palladium to increase the hydrogen gas concentration in the chamber 100.

The hydrogen absorber 5, the concentration part 300 having the heater 25 and the temperature sensor 20, and the hydrogen gas sensor element 500 or at least the hydrogen gas detection part 510 of the hydrogen gas sensor element 500 are inside the small chamber 100. The external gas is pulled or pushed into the chamber 100 with the introduction means 150 such as a suction pump or a discharge pump connected to the chamber 100 to make hydrogen gas fully absorbed in the hydrogen absorber 5. After a predetermined time has passed, for example, the heater 25 is heated to discharge the hydrogen gas absorbed in the hydrogen absorber 5 into the small chamber 100. The communicating hole 200 arranged in the chamber 100 has the airflow restriction part 250, which makes it difficult for gas to flow in by making the passage of the communicating hole 200 narrow, or which can close the communicating hole 200 with a valve. When the hydrogen absorbed in the hydrogen absorber 5 is discharged into the chamber 100 by joule heating of the heater 25 and the like, the hydrogen gas concentration in the chamber 100 is higher than that of the external gas since the airflow restriction part 250 makes it difficult for gas in the chamber 100 to leak outside and the inside volume of the chamber 100 is small. In other words, hydrogen gas is concentrated. The hydrogen gas concentrated in this way can be detected and measured with the hydrogen gas sensor element 500 arranged inside the chamber 100. For example, when the hydrogen gas concentration is 0.1 ppm in the external gas, the hydrogen gas sensor element 500 can measure hydrogen gas of 1 ppm since hydrogen gas is concentrated ten times. Therefore, even with the hydrogen gas sensor element 500 the detection limit of which is 1 ppm, hydrogen gas of 0.1 ppm can be detected.

In the hydrogen gas sensor relating in to another aspect of the present invention, introducing the external gas into the chamber 100 with the introduction means 150, absorbing the hydrogen gas in the external gas in the concentration part 300, concentrating the hydrogen gas in the chamber 100 with the airflow restriction part 250 while the absorbed hydrogen gas is discharged into the chamber 100 from the concentration part 300 with the heater 25, and outputting the information on the concentrated hydrogen gas with the hydrogen gas sensor element 500 can be performed in a predetermined cycle.

It takes about one minute, for example, to introduce the external gas including hydrogen gas to be detected into the chamber 100 with the introduction means 150 such as a suction pump and the like, fully replace the external gas introduced in the previous cycle, and make hydrogen gas in the external gas introduced anew in the previous cycle absorbed in the hydrogen absorber 5 in the concentration part 300 again, depending on the inside volume of the chamber 100 and the volume of the hydrogen absorber 5, in a case where the chamber 100 is micronized by MEMS technology, since these actions are performed via the airflow restriction part 250. In the present invention, since these actions are repeated cyclicly, the temporal change in the concentration of hydrogen gas included in the external gas can also be measured. By the cycle of the repeated actions, the amount of hydrogen absorbed in the hydrogen absorber 5 changes depending on the hydrogen gas concentration of the external gas. A predetermined cycle does not necessarily mean a cycle of a constant period. It only needs to be repeated.

In the hydrogen gas sensor relating to another aspect of the present invention, palladium is used as the hydrogen absorber 5.

In a palladium film as the hydrogen absorber 5, unlike in a platinum film, an exothermic reaction is generated in the course of absorbing hydrogen. Moreover, since hydrogen gas molecules (H2) exist both in a molecule adsorbing state and a dissociation adsorbing state, the dissociated hydrogen atoms are absorbed in the hydrogen absorbing film via the dissociation adsorbing state of the hydrogen gas molecules and discharged again as the hydrogen gas molecules (H2) from the hydrogen absorbing film. Therefore, by using palladium as the hydrogen absorber 5, hydrogen can be absorbed and discharged smoothly. Palladium is suitable for the hydrogen absorber 5 since it is hardly oxidized and easily reduced when oxidized. It is also known that palladium, which is used for highly purifying hydrogen gas, absorbs only hydrogen and permeates it by pressure. Therefore, palladium is a material of extremely high selectivity to hydrogen gas. By utilizing this property, it is possible to concentrate only hydrogen inside the chamber 100 by making only hydrogen absorbed in palladium as the hydrogen absorber 5 and discharging it into the chamber 100 with the heater. Since palladium can absorb hydrogen of the volume of over a hundred times as much as its volume, it is easy to concentrate hydrogen gas about ten times.

The palladium film as the hydrogen absorber 5 can be easily deposited by sputtering, ion plating, electron beam vapor deposition and the like. It is preferable to form the hydrogen absorber 5 into a thin film shape, because a surface area contacting hydrogen gas is large, the heat capacity is small, the high-speed responsibility is obtained, it is possible to control the time to completion of hydrogen gas absorption by controlling its thickness, and it can be a flat thin film without needing to be porous or particulate.

In the hydrogen gas sensor relating to another aspect of the present invention, the concentration part 300 is formed in a thin film 10 thermally separated from a substrate 1.

A microminiature hydrogen gas sensor probe 600 in which the heater 25 and the concentration part 300 having the hydrogen absorber 5 and the temperature sensor 20 are formed in the thin film 10 thermally separated from the substrate 1 manufactured by MEMS technology is suitable for a hydrogen gas sensor with high-speed response. The diaphragm structure, the crosslinked structure, and the cantilever structure are suitable for the thin film 10 because of their small heat capacity. With these structures, power consumption of the heater 25 for discharging hydrogen gas absorbed in the hydrogen absorber 5 is reduced and hydrogen gas can be discharged more rapidly. For absorption and discharge of hydrogen gas into the hydrogen absorber 5, it is also preferable to make a surface area of the hydrogen absorber 5 as large as possible and form it into a thin film shape. The temperature sensor 20 is necessary for detecting temperature rise and absolute temperature while raising temperature with the heater 25. The temperature sensor 20 can also be used as the heater 25. By forming the small chamber 100 by MEMS technology, the hydrogen gas sensor probe 600 becomes very compact and a handy hydrogen gas sensor can be provided.

In the hydrogen gas sensor relating to another aspect of the present invention, the temperature sensor 20 is a temperature differential sensor.

By using a temperature differential sensor which can measure the temperature difference alone such as a thermocouple and a thermopile as the temperature sensor 20, the hydrogen gas concentration can be measured on the basis of the temperature of time when hydrogen gas does not exist with only one diaphragm-shape or cantilever-shape thin film 10 in which the hydrogen absorber 5 and the temperature sensor 20 are formed, without necessarily using a sensor for reference which does not form the hydrogen absorber 5. Moreover, it is extremely preferable to use a temperature differential sensor such as a thermocouple and a thermopile for the measurement point (the hot junction) in a region of the thin film 10 where the hydrogen absorber 5 is arranged or the vicinity thereof setting the substrate 1 as the reference point (the cold junction), since the temperature difference between room temperature and the hydrogen absorber 5 can be extracted as the output, which is amplified as it is to apply the zero method. Such temperature sensors are inexpensive because of its small size and mass productivity.

In the hydrogen gas sensor relating to another aspect of the present invention, the hydrogen gas sensor element 500 is any one selected from a hydrogen gas sensor of a contact combustion type, a hydrogen gas sensor using heat generation by absorbing or adsorbing hydrogen, a hydrogen gas sensor of a semiconductor type, and a hydrogen gas sensor of a FET type.

A sensor which can be manufactured by MEMS technology is suitable for the hydrogen gas sensor element 500, especially its hydrogen gas detection part 510, since they are preferably formed in the microminiature size for being arranged inside the small chamber 100. A hydrogen gas sensor of a contact combustion type, which needs to be equipped with a temperature differential sensor, utilizes a heat generating action caused by a catalytic reaction with hydrogen gas while heating a catalyst layer such as platinum as the hydrogen sensitive layer 6. A hydrogen gas sensor which utilizes a heat generating action caused by absorbing or adsorbing hydrogen utilizes an exothermic reaction of time when hydrogen gas is absorbed or adsorbed in the hydrogen absorbing film such as palladium film as the hydrogen sensitive layer 6 at the low temperature such as room temperature, measuring the temperature rise thereof with the temperature sensor. Moreover, oxygen or adsorbed oxygen of an oxide film on the palladium film causes an exothermic reaction with adsorbed hydrogen even at room temperature, serving as a hydrogen gas sensor of high sensitivity and high selectivity to hydrogen. Therefore, in a case where oxygen exists on the surface of the palladium film, the temperature rise is greater and higher sensitivity can be obtained than in a case where hydrogen is simply absorbed in the palladium film. However, in hydrogen gas of high concentration, an oxide film and adsorbed hydrogen on the palladium film the temperature of which is raised by the heater are reduced to lose oxygen and the amount of exothermic reactions caused by the reaction between oxygen and hydrogen at around room temperature becomes small. Therefore, it is preferable to form an oxide film and the like. In hydrogen gas of low concentration, high sensitivity can be maintained since oxidation and oxygen adsorption are stronger than reduction under existence of hydrogen gas and oxygen exists on the palladium film even at room temperature.

A hydrogen gas sensor of a semiconductor type and a hydrogen gas sensor of a FET type utilizes the change in equivalent electric resistance of the hydrogen detection part 510 caused by adsorbing hydrogen gas and the like, measuring an electric current flowing in the sensor under a constant bias voltage. Of course, the electric current can be converted into voltage for being measured. Also in these hydrogen gas sensors, it is necessary to immediately ejecting the hydrogen absorbed or adsorbed in the hydrogen gas detection part 510. For this purpose, raising the temperature with the heater is recommended. The heater 25 for ejecting the hydrogen absorbed in the hydrogen absorber 5 is used as the heater for this purpose. Generally, a hydrogen gas sensor of a semiconductor type, equipped with the hydrogen sensitive layer 6 such as tin oxide in the hydrogen gas detection part 510, detects hydrogen gas by utilizing the change in electric resistance of the hydrogen sensitive layer 6 based on a reduction reaction on the surface caused by hydrogen which is heated to the high temperature of around 300° C.

In the hydrogen gas sensor relating to another aspect of the present invention, the hydrogen gas sensor element 500 is formed in a semiconductor substrate.

By using a semiconductor substrate, it is possible to easily form the thin film 10 and the thin film 11 in a diaphragm shape or a cantilever shape by MEMS technology, and it is also possible to easily form integrated circuits as signal processing circuits in the same substrate. Especially, when using an SOI substrate having an SOI layer, it is easy to uniformly form the hydrogen gas sensor element 500. Moreover, by mature semiconductor integration technology, various electric circuits such as an OP amplifier, a memory circuit, an operation circuit, a heater drive circuit, a display circuit and the like can be formed here. When machining the substrate itself three-dimensionally by MEMS technology using anisotropic etching technology and the like, the space in which these integration electric circuits are formed becomes insufficient and the substrate tends to become large. Moreover, since anisotropic etching and the like are performed after integration electric circuits are formed for manufacturing reasons, there is a risk that wirings of integration electric circuits are unbearable to chemicals used for anisotropic etching. In such a case, using sacrificial layer etching technology, by forming the thin film 10 and the thin film 11, where the temperature sensor 20 and 21, the heater 25 and 26, the hydrogen absorber 5, and the thin film of the hydrogen sensitive layer 6, thermally separated from the substrate in a shape floating in the air stacked on the substrate and by forming integration electric circuits also in the lower substrate such as a silicon single crystal substrate, it is possible to utilize the area effectively and the compact hydrogen gas sensor probe 600 can be provided. When forming the thin film 10 with poly silicon, an insulator such as an oxide film can be easily formed, the thin film 10 can be formed as a thermocouple as the temperature differential sensor, the temperature sensor can be used as the heater, and palladium can also be formed as the hydrogen absorber 5 or the hydrogen sensitive layer 6 by spattering and the like. It can be easily formed by a dry process using known MEMS technology.

The hydrogen gas sensor probe relating to another aspect of the present invention is a hydrogen gas sensor probe 600 used in the hydrogen gas sensor according to any one of claims 1 to 7, wherein at least the concentration part 300 and a hydrogen gas detection part 510 of the hydrogen gas sensor element 500 are inside the chamber 100 and wherein the chamber 100 comprises the communicating hole 200 having the airflow restriction part 250.

In the hydrogen gas sensor probe 600, it is preferable to use the chamber 100 formed by stacking cavitary semiconductor substrates formed by MEMS technology. It is preferable to use a palladium spattering thin film as the hydrogen absorber 5 of the concentration part 300 inside this chamber 100, to form a hardly oxidized nichrome thin film with a small temperature coefficient of resistance and a high resistivity by spattering and the like in the heater 25, to form the temperature sensor 20 with a thermocouple consisting of an SOI layer and a metal film, and to arrange these components on the diaphragm shape or crosslinked shape or cantilever shape thin film 10 floating in the air which consists of SOI layers, since these components can be easily formed by MEMS technology. It is preferable to form the hydrogen gas sensor element 500 also by MEMS technology to make it compact.

Also in the communicating hole 200, a long narrow V-groove and the like can be formed as the airflow restriction part 25 by MEMS technology. A thin film shape movable valve as the airflow restriction part 25 can be formed in the entrance of the long narrow V-groove of the communicating hole 200. The movable valve is usually closed, and is preferably opened by an airflow when introducing the external gas into the chamber 100 by sucking. Moreover, it is preferably so configured that the closed state can be tightly kept by increasing pressure inside the chamber 100 when the absorbed hydrogen is discharged from the hydrogen absorber 5 of the concentration part 300 by raising temperature with the heater.

It is preferable to arrange an exhaust port as the communicating hole 200 as a suction pump for introducing the external gas into the chamber 100. The exhaust port is preferably equipped with a pipe or a tube.

In the hydrogen gas sensor in the present invention, wherein the external gas is introduced into the chamber 100 with a small volume and absorbed in the hydrogen absorber 5 of the concentration part 300 arranged in the chamber 100 and wherein the hydrogen absorbed in the hydrogen absorber 5 is discharged into the chamber 100 while restricting airflow via the airflow restriction part 250, the discharged hydrogen gas hardly leaks outside of the chamber 100 even if the hydrogen gas concentration in the external gas is extremely low. Therefore, the hydrogen gas in the chamber 100 is concentrated over ten times more than the hydrogen gas in the external gas, thereby a highly sensitive hydrogen gas sensor can be provided.

In the hydrogen gas sensor in the present invention, the kind of the hydrogen gas sensor element 500 can be selected since it can be arranged apart from the hydrogen absorber 5 of the concentration part 300 for absorbing hydrogen gas in the external gas. Since the selectivity to hydrogen is left to the hydrogen absorber 5, it is not required in the hydrogen gas sensor element 500.

In the hydrogen gas sensor in the present invention, since the concentration part 300 can be served as the hydrogen gas sensor element 500, a very compact hydrogen gas sensor probe 600 can be provided.

The hydrogen gas sensor in the present invention is inexpensive, since a uniform and mass-produced hydrogen gas sensor probe the chamber 100 of which is made microminiature of several millimeters by MEMS technology can be provided.

In the hydrogen gas sensor in the present invention, since the temperature change accompanied by heating and cooling using the heater 25 can be measured at the basis of the ambient temperature by using the temperature differential sensor as the temperature sensor 20, the temperature rise caused by Joule heating can be easily measured. By providing the substrate 1 having the heater 25 with the absolute temperature sensor 23, the absolute temperature of the substrate 1 and the heater 25 can also be measured.

In the hydrogen gas sensor in the present invention, by forming the heater 25 and the concentration part 300 having the hydrogen absorber 5 and the temperature sensor 20 in the thin film 10 and using the temperature differential sensor such as a thermopile and a thermocouple as the temperature sensor 20, the compact hydrogen gas sensor probe 600 can be provided since the temperature sensor 20 the temperature of which is raised by Joule heating can serve as the heater. Especially, in a case where the temperature sensor 20 is a thermocouple, the zero method can be applied since the temperature sensor is used as the temperature differential sensor in the cooling process after heating the thermocouple for using it as the heater 25.

In the hydrogen gas sensor in the present invention, by forming the hydrogen gas sensor element 500 in the semiconductor substrate, a temperature sensor using a semiconductor such as a diode and an integrated circuit such as a signal processing circuit can be formed by mature semiconductor integration technology.

In the hydrogen gas sensor in the present invention, by forming the concentration part 300 in the thin film 10 floating in the air, heating and cooling can be rapidly performed with low power consumption and discharging hydrogen by heating can also be performed easily and rapidly.

Embodiments of the invention will now be described.

The hydrogen gas sensor probe which is the base of the hydrogen gas sensor in the present invention can be made of a silicon substrate which can also form IC by mature semiconductor integration technology and MEMS technology. Although the heater 25, the substrate 1 mounted with the concentration part 300 having the hydrogen absorber 5 and the temperature sensor 20, the hydrogen gas sensor element 500, the cover 2, the cover 3 and the like are not necessarily required to be made of a silicon substrate, the following detailed description, which is referring to figures and based on embodiments, is related to a case where a silicon substrate is used for manufacturing these components. The configuration of an embodiment in which the hydrogen gas sensor in the present invention is embodied as the hydrogen gas measuring apparatus will be also described with a diagram.

### Embodiment 1

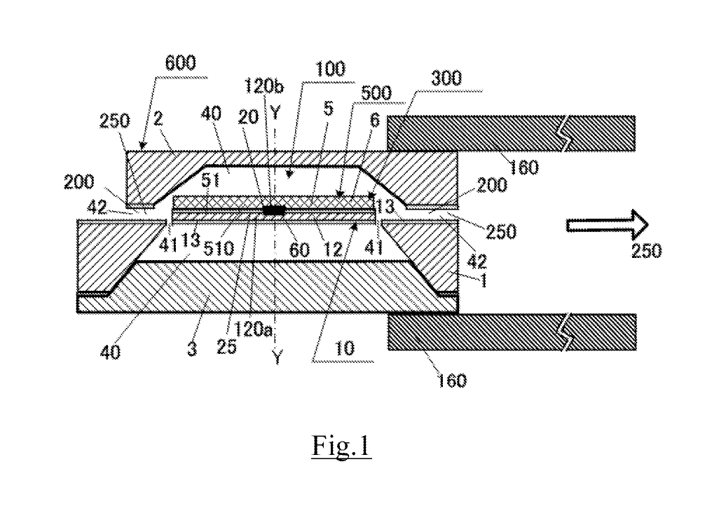

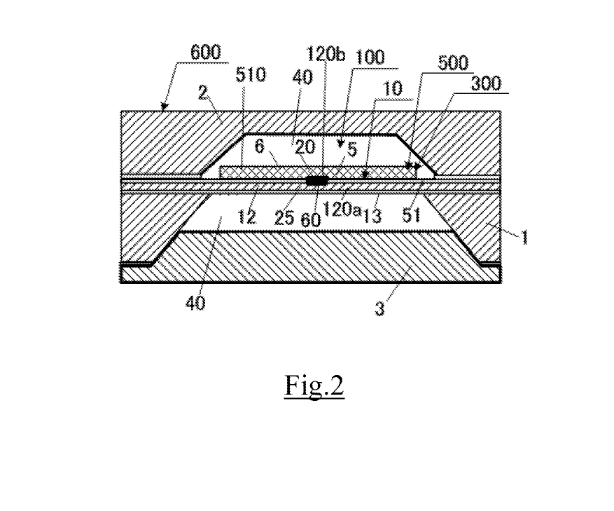

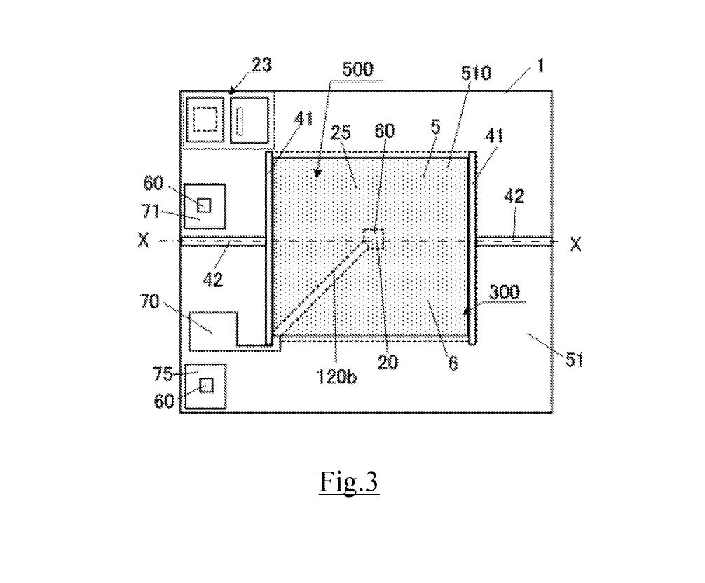

FIG. 1 is a cross-sectional schematic view illustrating an embodiment of the hydrogen gas sensor probe 600 equipped with the tube 160 characterizing the hydrogen gas sensor in the present invention. FIG. 2 is a cross-sectional schematic view along Y-Y line in FIG. 1. FIG. 3 is a plane schematic view illustrating an embodiment of the substrate 1 in the hydrogen gas sensor probe 600 illustrated in FIG. 1 and FIG. 2. Here, an SOI substrate is used as the substrate 1 and the thin film 10 is crosslinking the cavity 40, being thermally separated from the substrate 1 and floating in the air. The thin film 10 is equipped with the heater 25 and the concentration part 300 having the temperature sensor 20 and the hydrogen absorber 5.

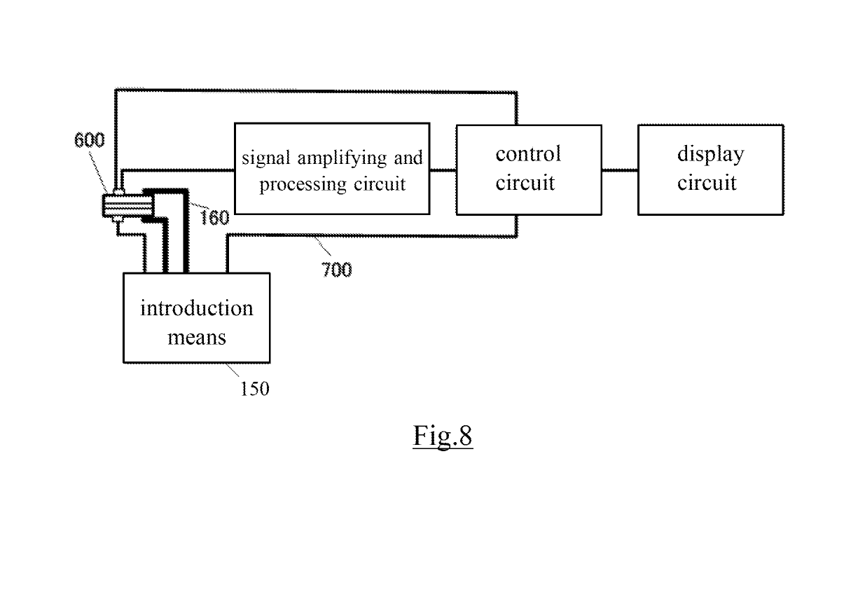

Here, a thermocouple in which the heater 25 and the temperature sensor 20 are partially shared as the temperature differential sensor 20 is formed and Joule heating is performed by feeding a current to the heater 25. Moreover, the concentration part 300 serves as the hydrogen gas sensor element 500 for making the configuration the simplest. The hydrogen gas sensor probe 600 is equipped with the tube 160, another end of which is equipped with the introduction means 150 such as a pump for introducing the eternal gas into the chamber 100 by sucking. The embodiment of the configuration in which the hydrogen gas sensor in the present invention is used as the hydrogen gas measurement apparatus is illustrated as a diagram in FIG. 8. In FIG. 8, a case where the external gas including hydrogen gas to be detected is introduced into the micro chamber 100 via the tube 160 with the introduction means 150 such as a suction pump, the signal communication with the hydrogen gas sensor probe 600 is performed via the cable 700, and the signal processing circuit for communicating signals with the hydrogen gas sensor element 500 in the hydrogen gas sensor, the operation circuit, the amplification circuit, the circuit for controlling the timing and the cycle of the hydrogen gas sensor operation, the circuit for displaying the hydrogen gas concentration and the like are also provided, is illustrated.

Next, the structure of the hydrogen gas sensor probe 600 illustrated in FIG. 1 in the present embodiment will be described. The plane schematic view of the n-type SOI substrate 1 is illustrated in FIG. 3. Here, the thin film 10 crosslinked by the slits 41 at both sides is formed by forming the cavity 40 by etching and removing the back of the substrate 1, leaving the SOI layer 12 the thickness of which is 10 micrometers, for example. In the thin film 10, a metal film (a nichrome thin film bearable to anisotropic etchant of silicon, for example) as one thermoelectric material 120b for forming the temperature sensor 20 as a thermocouple via an electrically insulating film which is a thermal oxide SiO2 film is formed by spattering deposition and the like. The n-type SOI layer 12 of the crosslinking thin film 10 is used for the other thermoelectric material 120a. The thermoelectric material 120a and the thermoelectric material 120b are electrically connected by forming an ohmic electrode 60 as the measurement point (the hot junction) of the thermocouple as the temperature sensor 20 in the center of the thin film 10 which becomes the highest temperature when heating the crosslinking thin film 10 by Joule heating. The reference points (the cold junctions) of the thermocouple are an electrode pad 70 and a common electrode pad 75 of the substrate 1 illustrated in FIG. 3. The temperature of the reference points is the temperature of the substrate 1 in which the reference points exist.

Here, palladium as the hydrogen absorber 5 is deposited at large thickness of about 2-3 micrometers by spattering to absorb and store hydrogen gas. The volume of the palladium as the hydrogen absorber 5 is important. The hydrogen absorbed here is discharged by Joule heating in the heater 25 and the chamber 100 the inside volume of which is small, which is called the micro chamber 100, is filled with the hydrogen. The present invention is intended to provide high sensitivity by measuring the hydrogen gas concentrated by increasing the concentration inside the chamber 100 with the hydrogen gas sensor element 500. Therefore, to provide a highly sensitive hydrogen gas sensor, it is preferable to make the area of the crosslinking thin film 10 as large as possible and form the palladium film as the hydrogen absorber 5 on it.

In the present embodiment, as described above, the heater 25 and the concentration part 300 having the temperature sensor 20 and the hydrogen absorber 5 which are formed in the thin film 10 serve as the hydrogen gas sensor element 500. The hydrogen absorber 5 is also used as the hydrogen sensitive layer 6 of the hydrogen gas detection part 510. After introducing the external gas into the micro chamber 100 and making it absorbed in the hydrogen absorber 5 for thr predetermined period, the absorbed hydrogen is heated to the predetermined temperature to be discharged into the micro chamber 100, thereby beginning to operate as the hydrogen sensor element 500. Therefore, against the volume inside the micro chamber 100, how much the hydrogen gas concentration inside the micro chamber 100 is increased compared to the hydrogen gas concentration of the external gas by being absorbed in the hydrogen absorber 5 and discharged is important. The identical hydrogen gas sensor element 500 is made highly sensitive for the increase. The communicating hole 200 which makes airflow resistance large, which is used as the airflow restriction part 250, is formed by forming the narrow groove 42 by removing a part of the SOI layer 12 of the substrate 1 by etching and putting on the cover 2. The external gas hardly enters the airflow restriction part 250 because of large airflow resistance. The hydrogen gas discharged from the hydrogen absorber 5 also hardly leaks outside the micro chamber 100. In this way, hydrogen gas inside the micro chamber 100 is concentrated with the hydrogen gas discharged from the hydrogen absorber 5. For example, in a case where the hydrogen gas concentration of the external gas is 1 ppm, if the hydrogen gas concentration inside the micro chamber 100 becomes ten times as large by being absorbed in the hydrogen absorber 5 and discharged, the hydrogen gas is concentrated to 10 ppm in the hydrogen gas sensor element 500, thereby the hydrogen gas of 10 ppm is measured. A heat-resistant and electrically insulating adhesive with good adhesiveness such as a polyimide and a water glass is suitable for joining the substrate 1 with the cover 2 and 3.

In the present invention, using the hydrogen absorber 5 in the concentration part 300 as the hydrogen sensitive layer 6 in the hydrogen gas sensor element 500, the temperature rise of the thin film 10 based on an exothermic reaction of time when it absorb or adsorb hydrogen is measured with a thin film thermocouple as the temperature sensor 20, which consists of the thermocouple conductor 120a as the n-type SOI layer 12 forming the thin film 10 and the thermocouple conductor 120b as the metal film. In a case where the hydrogen gas sensor element 500 is used, as described above, after making hydrogen absorbed in the hydrogen absorber 5 for the predetermined period, the hydrogen absorber 5 is used again as the hydrogen sensitive layer 6 in the cooling process after heating hydrogen with the heater 25 to the predetermined temperature 200° C., for example, and discharging it into the micro chamber 100. Then, the temperature rise caused by an exothermic reaction of time when hydrogen is absorbed or adsorbed is measured again with the temperature sensor 20 and converted to the detected hydrogen gas concentration in the external gas utilizing the hydrogen gas concentration data previously prepared. By feeding a current for Joule heating to a part of the temperature sensor 20 as a thermocouple in which the zero method can be used, it becomes possible to heat it to about 200° C. for discharging hydrogen. After that, in the cooling process after stopping heating, the hydrogen gas concentration can be measured with high accuracy utilizing the original action as the temperature sensor. As the substrate 1 in which the reference temperature of the temperature differential sensor 20 can be thought the same as room temperature, which is the temperature of atmosphere gas, the thermocouple electrode pad 70 and the thermocouple common electrode pad 75 are arranged to be the reference point (the cool junction) of the thermocouple as the temperature differential sensor. The absolute temperature sensor 23 is arranged in the substrate 1 for measuring the temperature of the substrate 1, which is the reference temperature. Here, the absolute temperature sensor 23 is a pn junction diode.

The embodiment of the operation of the hydrogen gas sensor element 500 in the present embodiment will be described in more detail below. In a case where the length of the thin film 10 is about 500 micrometers and the thickness of the SOI layer 12 is about 10 micrometers, a thermal time constant T of the crosslinking thin film 10 is about 10 milliseconds. In a case where the SOI layer is n-type and resistivity of about 0.01 ohm centimeter is used, a resistance value of the heater 25 between the common electrode pad 75 and the electrode pad 71 for the heater 25 from the SOI layer 12 of the thin film 10 is about 100 ohms. The hydrogen gas to be detected absorbed in the hydrogen absorber 5 is heated to about 200° C. by heating power of about 100 milliwatts and discharged into the micro chamber 100.

Next, after stopping heating of the heater 25 by making applied voltage for heating zero, Seebeck voltage between the electrode pad 70 as the temperature sensor 20 and the common electrode pad 75 is measured. After stopping heating, at the time four to five times as much as a thermal time constant T, output voltage of Seebeck voltage in the temperature sensor 20 as the thermocouple is zero with the absence of hydrogen gas. However, since the thin film 10 has the hydrogen absorbing film 5, the temperature rises due to an exothermic reaction during cooling in the hydrogen sensitive layer 6 as the hydrogen absorbing film 5 based on absorption or adsorption of hydrogen gas, thereby output voltage between the electrode pad 70 and the common electrode pad 75, which is Seebeck voltage of the temperature sensor 20, can be measured. The value of output voltage is measured as a monotonous function of the hydrogen gas concentration in a range of low hydrogen gas concentration. Therefore, the hydrogen gas concentration can be calculated using previously prepared data on the relationship between the hydrogen gas concentration in atmosphere gas and output voltage after the specific time passes after stopping heating, which is calibration data. In this case, if the hydrogen gas concentration is 0%, output voltage of Seebeck voltage of the temperature sensor 20 should be essentially zero at the time when four to five times as much as a thermal time constant T passes after stopping heating. Therefore, the hydrogen gas concentration can be preferably measured in a range of low hydrogen gas concentration, since the zero method can be applied. In a case where the hydrogen absorbing film 5 as the hydrogen sensitive layer 6 is palladium, it is preferable that oxygen gas exists in the external gas, since an exothermic reaction in the hydrogen sensitive layer 6 at room temperature becomes strong in the presence of oxygen adsorption or an oxide palladium film at the surface.

An outline of the manufacturing process for processing the substrate 1 in the hydrogen gas sensor in the present invention illustrated in FIG. 1, FIG. 2, and FIG. 3 will be described below. In a case where the SOI layer 12 of the substrate 1 is n-type, it is preferable to form an n-type thermal diffusion area in the ohmic electrode by known semiconductor fine processing technology 60 to obtain good ohmic contact, since the thermocouple as the temperature differential sensor is used as the temperature sensor 20 and the heater 25. The pn junction diode, which can be easily formed by known diffusion technology, is formed as the absolute temperature sensor 23 arranged in the substrate 1. In the metal thermocouple conductor 120b, which generates differential amplification, all of the wirings and the electrodes pads need to be made of the same metal considering Seebeck effect. Nichrom or Nickel based metals are suitable, since they are resistant to strong alkali based etchant. When dry etching and the like are performed and it is not exposed to strong alkali based etchant, it is preferable to form ohmic electrodes, the wiring 110, and the electrode pads by spattering and photolithography, using an aluminum-based metal. An exclusive etchant is used for patterning the palladium film as the hydrogen absorber 5 and dry etching is performed as needed. The cavity 40 and the slit 41 formed in the substrate 1 can be penetrated from its back surface by being formed by etchant or DRIE. Here, one common electrode pad 75 is used for both of a terminal at the side of the n-type SOI layer 12 which is used as the reference point (the cold junction) of the thermocouple in the temperature sensor 20 formed in the thin film 10 and a terminal of the heater 25.

### Embodiment 2

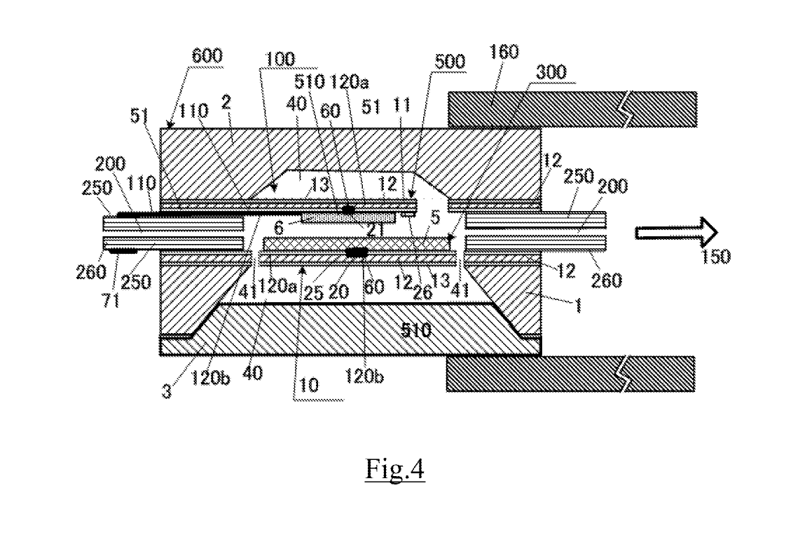

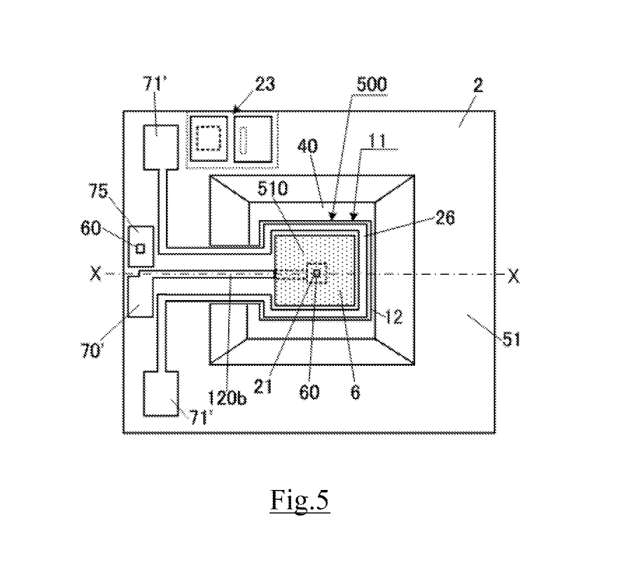

FIG. 4 is a cross-sectional schematic view illustrating another embodiment of the hydrogen gas sensor probe 600 equipped with the tube 160 characterizing the hydrogen gas sensor in the present invention. FIG. 5 is a plane schematic view illustrating an embodiment of the cover 2 equipped with the hydrogen gas sensor element 500 in the hydrogen gas sensor probe 600 illustrated in FIG. 4. In the cover 2, the SOI layer 12 is made of silicon single crystal substrates. The major difference from the hydrogen gas sensor probe 600 in embodiment 1 illustrated in FIG. 1 to FIG. 3 is as follows. In embodiment 1, the heater 25 and the concentration part 300 having the temperature sensor 20 and the hydrogen absorber 5 formed in the crosslinking thin film 10 are used also as the hydrogen gas sensor element 500. Here, the hydrogen gas sensor element 500 is configured by forming the heater 26 and the hydrogen gas detection part 510 having the temperature sensor 21 and the hydrogen sensitive layer 6 in the cantilever-shape thin film 11 made of the different SOI layer 12, being arranged close to the thin film 10 via the spacer 260 in the micro chamber 100. Moreover, the spacer 260 operates as the airflow restriction part 250 with the communicating hole 200 formed in a long and narrow shape. Although the structure of the substrate 1 is the same as in embodiment 1, it is not used as the hydrogen gas sensor element 500.

Although the heater 26 and the temperature sensor 21 can be commonly used, they are separated in the present configuration. The heater 26 is arranged in the thin film 11 surrounding the hydrogen sensitive layer 6, for example, by spattering and photolithography with a nichrome thin film and the like so that the cantilever shape thin film 11 can be uniformly heated. Heater voltage is applied between the two electrode pads 71′ in the heater 25 for Joule heating. In a case where a hydrogen absorbing material such as a palladium film is used as the hydrogen sensitive layer 6 in the hydrogen gas sensor element 500 and heat generation caused by absorbing or adsorbing hydrogen is utilized, the method for measuring the hydrogen gas concentration of the external gas is basically the same as in embodiment 1, except that the concentration part 300 and the hydrogen gas sensor element 500 are separately arranged. By using palladium which absorbs only hydrogen as the hydrogen absorber 5 formed in the thin film 10 of the substrate 1, the absorbed hydrogen is discharged by heating to concentrate the hydrogen gas in the micro chamber 100. Therefore, since the palladium film as the hydrogen absorber 5 maintains a high selectivity to hydrogen gas, the hydrogen gas sensor with high selectivity to hydrogen gas can be provided, not necessarily requiring the hydrogen gas sensor element 500 formed at the side of the cover 2 to have selectivity to hydrogen gas. In FIG. 8, as described above, a diagram of an embodiment of the configuration in the hydrogen gas sensor in the present invention is illustrated.

In the case described above, a hydrogen absorbing material such as a palladium film is used as the hydrogen sensitive layer 6 formed in the thin film 11 and heat generation caused by absorbing or adsorbing hydrogen is utilized. A platinum catalyst in which platinum fine powders are mixed into alumina can also be used as the hydrogen sensitive layer 6. In this case, the hydrogen gas sensor element 500 can operate as a contact combustion type hydrogen gas sensor. It can also be used as the hydrogen gas sensor element 500 in which the temperature rise caused by contact combustion of the hydrogen gas to be detected is measured with the temperature sensor 21 made of the thermocouple as the temperature differential sensor after heating the thin film 11 to over 100° C. with the heater 26 made by a nichrome film, for example, which is arranged in the cantilever shape thin film 11 illustrated in FIG. 4 and FIG. 5. Since the concentration part 300 and the hydrogen gas sensor element 500 are separately arranged in the present embodiment, hydrogen gas detection with the hydrogen gas sensor element 500 need to be performed when the hydrogen gas concentration inside the micro chamber 100 is high. It is preferable to detect hydrogen gas while the hydrogen absorber 5 of the concentration part 5 is being heated to discharge hydrogen gas into the micro chamber 100.

In the present embodiment, the substrate 1 and the cover 2 are made by silicon crystals, crystal orientation of which is not considered. However, beams in the structure should preferably be long for the thin film 10 and the thin film 11 in a crosslinked structure or a cantilever structure to obtain large temperature rise using minute heat generation. In a case where an SOI substrate made of silicon single crystals is used for the substrate 1 or the cover 2, crystal orientation is important in anisotropic etchant for performing three-dimensional processing such as forming the cavity 40 and the slit 41 in the substrate 1 and the cover 2 by MEMS technology. It is because crystal orientation is utilized for forming the cavity 40 and the like with high accuracy by stopping etching using the fact that the etching speed in (111) surface of a crystal is extremely slower than the other orientations, for example. It is preferable to etch the crystal silicon in as short a time as possible considering the angle to the crystal orientation and the width of beams for forming a long beam in the narrow cavity 40.

### Embodiment 3

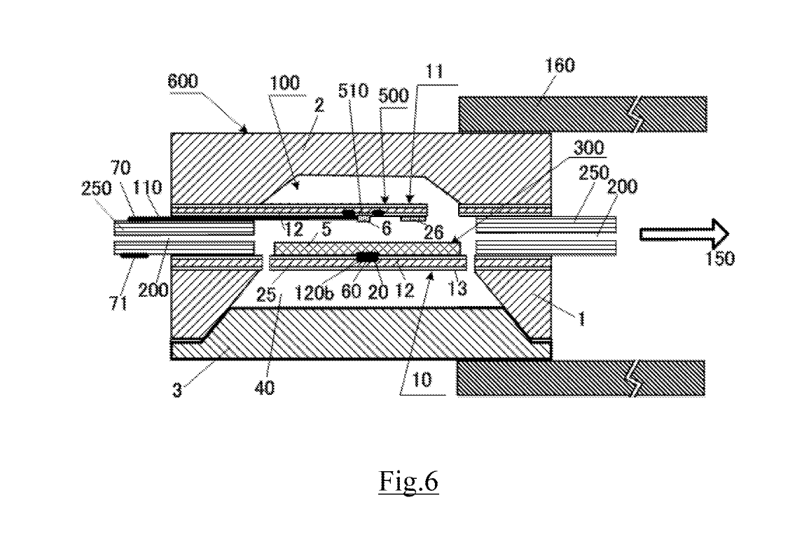

FIG. 6 is a cross-sectional schematic view illustrating another embodiment of the hydrogen gas sensor probe 600 equipped with the tube 160 characterizing the hydrogen gas sensor in the present invention. In the present embodiment, a hydrogen gas sensor of a FET type is used as the hydrogen gas sensor element 500 in embodiment 2, an SOI substrate is used for the cover 2 as in embodiment 2, and MOSFET is formed as the hydrogen detection part 510 by using the SOI layer 12. Moreover, a platinum film a work function of which changes when absorbing hydrogen is used as the hydrogen sensitive layer 6. The other structures are completely the same as in embodiment 2. The operation principle of a hydrogen gas sensor of a FET type is as follows. The platinum film a work function of which mainly changes equivalently when absorbing hydrogen on the gate oxide film of MOSFET is formed as the hydrogen sensitive layer 6. The change in a work function caused by surface adsorption of hydrogen gas is exactly equivalent to the change in gate voltage of MOSFET. Then, channel resistance of MOSFET changes, thereby drain current Id which means current between the source S and the drain D changes. The change in Id is converted into the hydrogen concentration. Since it takes time to discharge the hydrogen adsorbed or absorbed in the hydrogen sensitive layer 6 at room temperature, it is preferable to discharge it by raising the temperature with the heater. For this purpose, it is preferable to form MOSFET on the small thin film 11 floating in the air. The heater 26 is arranged for ejecting hydrogen. The hydrogen gas sensor element 500 can operate at room temperature. The method for introducing the external gas into the micro chamber 100 and the measuring method are the same as in embodiment 2, except for the operation of the hydrogen gas sensor element 500. In FIG. 8, as described above, a diagram of an embodiment of the configuration in the hydrogen gas sensor in the present invention is illustrated.

### Embodiment 4

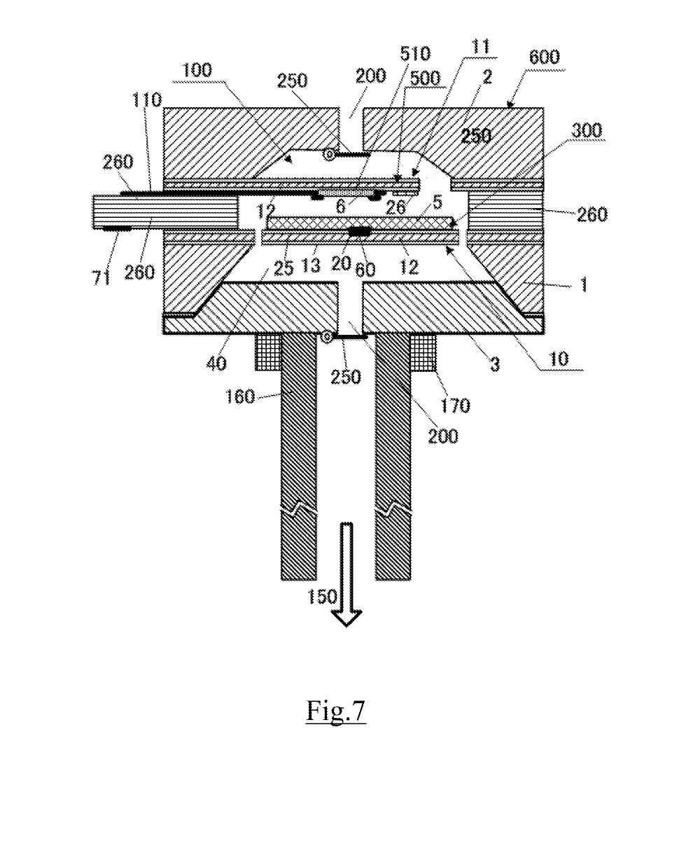

FIG. 7 is a cross-sectional schematic view illustrating another embodiment of the hydrogen gas sensor probe 600 equipped with the tube 160 characterizing the hydrogen gas sensor in the present invention. In the present embodiment, a hydrogen gas sensor of a semiconductor type is used as the hydrogen gas sensor element 500 in embodiment 2, an SOI substrate is used as the cover 2 as in the case of embodiment 2 and embodiment 3, and the hydrogen sensitive layer 6 such as tin oxide is formed as the hydrogen detection part 510 by using the SOI layer 12. In the same way as a conventional hydrogen gas sensor of a semiconductor type, after heating the hydrogen sensitive layer 6 such as tin oxide to about 300° C. with the heater 26, the change in electric resistance or flowing current of the hydrogen sensitive layer 6 caused by hydrogen gas adsorption or a reduction reaction is measured. The major differences from embodiment 1 to embodiment 3 are the position of the communicating hole 200 and the structure of the airflow restriction part 250. In the present embodiment, the communicating hole 200 is arranged in the cover 2 and the cover 3 and the spacer 260 which does not have a hole such as the communicating hole 200 is inserted between these for forming the micro chamber 100 which is approximately sealed while keeping the space between the substrate 1 and the cover 2. Here, the communicating hole 200 is arranged in the cover 2 and the cover 3, where the tube 160 is attached to the communicating hole 200 via the holding member 170. The valve, which is used as the airflow restriction part 250, is arranged in each entrance of the communicating hole 200. Of course, the groove 42 can be formed in the substrate 1 as the airflow restriction part 250 as in embodiment 1 and embodiment 2, for example, or the airflow restriction part 250 of the communicating hole 200 can be formed in the spacer 260. In a case where the airflow restriction part 250 is a valve, the rapid introduction of the external gas can be achieved since the inner diameter of the communicating hole 200 can be made large for smoothing coming in and out of an airflow.

The valve of the entrance of the communicating hole 200 can be formed by attaching a single side supporting valve of a plastic thin film, or can be formed by MEMS technology using a thin film formed by a CVD (Chemical Vapor Deposition method) or an SOI layer. In the present embodiment, the cycle of the operation of the hydrogen gas sensor in the present invention is exactly the same as in embodiment 2 and embodiment 3, except for the operation of the hydrogen gas sensor element 500 which has respective characteristics. In FIG. 8, as in the above, a diagram of an embodiment of the configuration in the hydrogen gas sensor in the present invention is illustrated.

The hydrogen gas sensor in the present invention is not limited to the present embodiment at all. It can be put into practice in various modes, keeping its gist and effects.

In the hydrogen gas sensor in the present invention, hydrogen gas can be detected and measured with high sensitivity even with the hydrogen gas sensor element 500 in the normal small size inside the micro chamber 100 by concentrating the hydrogen gas in the micro chamber 100, making extremely trace hydrogen gas in the external gas as atmosphere gas absorbed in the hydrogen absorber 5 formed in the thin film 10 floating in the air as the concentration part 300 and discharging it into the extremely small chamber 100 (micro chamber) by raising the temperature with the heater. The hydrogen gas sensor with extremely high selectivity to hydrogen can be provided even in a case where the hydrogen gas sensor element 500 does not have selectivity to hydrogen gas by using a material which absorbs only hydrogen such as palladium as the hydrogen absorber 5. Moreover, it is the most suitable for a hydrogen leak detector and the like as an inexpensive and handy hydrogen gas sensor, since it can be produced in the microminiature size and the large scale by mature MEMS technology. By concentrating hydrogen gas about ten times with the micro chamber 100, measuring hydrogen gas of 0.1 ppm becomes equivalent to measuring the hydrogen gas concentration of 1 ppm. Therefore, the hydrogen gas concentration of 0.1 ppm can be measured with the hydrogen gas sensor element the limit of which is 1 ppm. Such a hydrogen gas sensor with high sensitivity can be widely applied to industry.

The hydrogen gas sensor and the hydrogen gas sensor probe used in the same being thus described, it will be apparent that the same may be varied in many ways. Such variations are not to be regarded as a departure from the spirit and scope of the invention, and all such modifications as would be apparent to one of ordinary skill in the art are intended to be included within the scope of the following claims.

1-8. (canceled)

9. A hydrogen gas sensor comprising:
an airflow restriction part that is provided in a communicating hole, the airflow restriction part connecting between external gas which includes hydrogen gas and a chamber;
a concentration part that is configured to concentrate the hydrogen gas and that is provided in the chamber;
a hydrogen gas sensor element that is provided in the chamber;
a hydrogen absorber, a heater, and a temperature sensor that are provided in the concentration part; and
an introduction member that is configured to introduce the external gas into the chamber, wherein
hydrogen in the hydrogen gas included in the external gas is absorbed by the concentration part,
the hydrogen that is absorbed in the concentration part is discharged into the chamber by heating the hydrogen,
hydrogen gas concentration of the hydrogen gas increases by the airflow restriction part,
the hydrogen gas sensor element detects information relating to the hydrogen gas concentration of the concentrated hydrogen gas in the chamber so as to output the information, and
the hydrogen gas concentration in the external gas is obtained based on predetermined calibration data.

10. A hydrogen gas sensor probe used in the hydrogen gas sensor according to claim 9, wherein
at least the concentration part and a hydrogen gas detection part of the hydrogen gas sensor element are provided inside the chamber, and
the chamber includes the communicating hole having the airflow restriction part.

11. The hydrogen gas sensor according to claim 9, wherein
introduction of the external gas into the chamber by the introduction member, absorption of the hydrogen gas in the external gas in the concentration part, discharge of the absorbed hydrogen gas into the chamber from the concentration part by the heater, concentration of the hydrogen gas in the chamber by using the airflow restriction part, and output of the information on the concentrated hydrogen gas by the hydrogen gas sensor element are performed in a predetermined cycle.

12. A hydrogen gas sensor probe used in the hydrogen gas sensor according to claim 11, wherein
at least the concentration part and a hydrogen gas detection part of the hydrogen gas sensor element are provided inside the chamber, and
the chamber includes the communicating hole having the airflow restriction part.

13. The hydrogen gas sensor according to claim 9, wherein
the hydrogen absorber is palladium.

14. A hydrogen gas sensor probe used in the hydrogen gas sensor according to claim 13, wherein
at least the concentration part and a hydrogen gas detection part of the hydrogen gas sensor element are provided inside the chamber, and
the chamber includes the communicating hole having the airflow restriction part.

15. The hydrogen gas sensor according to claim 9, wherein
the concentration part is formed in a thin film that is thermally separated from a substrate.

16. A hydrogen gas sensor probe used in the hydrogen gas sensor according to claim 15, wherein
at least the concentration part and a hydrogen gas detection part of the hydrogen gas sensor element are provided inside the chamber, and
the chamber includes the communicating hole having the airflow restriction part.

17. The hydrogen gas sensor according to claim 9, wherein
the temperature sensor is a temperature difference sensor.

18. A hydrogen gas sensor probe used in the hydrogen gas sensor according to claim 17, wherein
at least the concentration part and a hydrogen gas detection part of the hydrogen gas sensor element are provided inside the chamber, and
the chamber includes the communicating hole having the airflow restriction part.

19. The hydrogen gas sensor according to claim 9, wherein
the hydrogen gas sensor element is one of a contact combustion hydrogen gas sensor, a hydrogen gas sensor using heat generation by absorbing or adhering the hydrogen, a semiconductor hydrogen gas sensor, and a field effect transistor hydrogen gas sensor.

20. A hydrogen gas sensor probe used in the hydrogen gas sensor according to claim 19, wherein
at least the concentration part and a hydrogen gas detection part of the hydrogen gas sensor element are provided inside the chamber, and
the chamber includes the communicating hole having the airflow restriction part.

21. The hydrogen gas sensor according to claim 19, wherein
the hydrogen gas sensor element is formed in a semiconductor substrate.

22. A hydrogen gas sensor probe used in the hydrogen gas sensor according to claim 21, wherein
at least the concentration part and a hydrogen gas detection part of the hydrogen gas sensor element are provided inside the chamber, and
the chamber includes the communicating hole having the airflow restriction part.
